(19) United States
(12) Patent Application Publication
(10) Pub. No.: US 2015/0220537 A1
(43) Pub. Date: Aug. 6, 2015

(54) System & Method for Constructing, Augmenting & Rendering Multimedia Stories

(71) Applicants: Patrick A. COSGROVE, Honeoye Falls, NY (US); Steven J. SASSON, Hilton, NY (US); John R. McCOY, Webster, NY (US); Ben K. GIBSON, Rochester, NY (US); Mark A. SCHNEIDER, Ridgefield, WA (US); Paul E. SCHILLE, Portland, OR (US); Eiryanna M.K. BENNETT, Portland, OR (US)

(72) Inventors: Patrick A. COSGROVE, Honeoye Falls, NY (US); Steven J. SASSON, Hilton, NY (US); John R. McCOY, Webster, NY (US); Ben K. GIBSON, Rochester, NY (US); Mark A. SCHNEIDER, Ridgefield, WA (US); Paul E. SCHILLE, Portland, OR (US); Eiryanna M.K. BENNETT, Portland, OR (US)

(73) Assignee: KIBRA LLC, Ridgefield, WA (US)

(21) Appl. No.: 14/614,245

(22) Filed: Feb. 4, 2015

Related U.S. Application Data
(60) Provisional application No. 61/936,775, filed on Feb. 6, 2014.

(51) Int. Cl. G06F 17/30; H04L 29/06; H04L 29/08; G06F 21/30; G06F 21/60

(52) U.S. Cl. CPC G06F 17/30058; G06F 21/30; G06F 17/30501; G06F 21/60; H04L 67/10; G06F 17/30598; G06F 17/30516; H04L 65/60

(57) ABSTRACT

Systems to manage the collection of multimedia and physical-sensor data automatically strike a balance between resources utilized to perform the collection, and the usefulness of the data recorded. The recorded data may be augmented with additional data or data streams, and the resulting dataset is automatically composited to produce an audience presentation focusing on selected aspects of the full dataset. The same source dataset may be composited differently to produce another presentation with a different purpose, theme or focus.

### CONTINUITY AND CLAIM OF PRIORITY

This original U.S. patent application claims priority to U.S. provisional patent application No. 61/936,775 filed 6 Feb. 2014. The entire content of said provisional patent application is incorporated herein by reference.

### FIELD

The invention relates to multimedia and digital data processing systems. More specifically, the invention relates to systems and methods for capturing electronic data representing various physical measurements, augmenting and manipulating said data to enrich it, and filtering and rendering the enriched data to produce a multimedia story with a significant reduction in user time and effort.

### BACKGROUND

A variety of portable, personal electronic devices are commonly carried to provide services to their owners: cell phones, Global Positioning System (“GPS”) devices, digital cameras (still and video), music players and recorders, and so on. With increasing miniaturization and integration, single devices often incorporate many different features, and contain other sensors besides those typically included in a smart phone. . For example, a cell phone often has a camera, GPS, audio recording and sound playback facilities, as well as multi-axis accelerometers, magnetometers, thermometers and ambient-light sensors. Other electronic devices may be particularly capable in one respect, but may also include auxiliary sensors and communication interfaces. One current trend is around wearable devices which contain sensors of various sorts, including physiological measures in support of sports training.

These devices are generally controlled by software that performs the low-level coordination and control functions necessary to operate the various peripherals, with a higher-level user interface to activate and direct the user-visible facilities. With few exceptions, the devices can be thought of generally as producers, manipulators or consumers of digital data that is related to some physical state or process. For example, a digital camera converts light from a scene into an array of color and intensity pixel values; a GPS receiver uses signals from a constellation of satellites to compute the location of the receiver; and an accelerometer produces numbers indicating changes in the device's velocity over time. This digital data can be used immediately (for example, accelerometer data indicating that the device is in free fall may be used to switch a hard disk into park mode pending an anticipated sudden stop) or it can be stored for later replay or processing.

In view of the wealth of data being produced (to say nothing of the related data produced by nearby people's devices and fixed devices in the area), it is a challenge to select the most relevant and useful material and to place it in a pleasing form for subsequent access. Culling continuously-collected data by hand is practically impossible, but relying on a user pressing “Record” to start and stop collection is bothersome, and risks missing unexpected or serendipitous events.

An automatic system for configuring, commencing, collecting, culling, correlating and compositing varied data streams may be of significant value in this field.

### SUMMARY

A system collects information from physical sensors such as cameras, microphones, GPS receivers, accelerometers and the like to produce a multimedia dataset referred to as a “Event Kernel.” Heuristics are used to improve resource utilization during recording, and optimize capture sampling rates. The event kernel may be augmented with non-physical-sensor data such as calendar or appointment information, physical-location metadata or identity information of people present - or by creating higher order information by performing computational analysis on the lower level sensor data. Two different Event Kernels captured near the same time and/or place may also be combined. Finally, an automatic or semi-automatic compositing system is used to produce a predetermined type of presentation based on the information in the Event kernel. The same Event Kernel can be used to produce different presentations to fit different needs at different times.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 Show the consumer experience with the proposed system and the relationship between the capture experience and the post-capture experience.

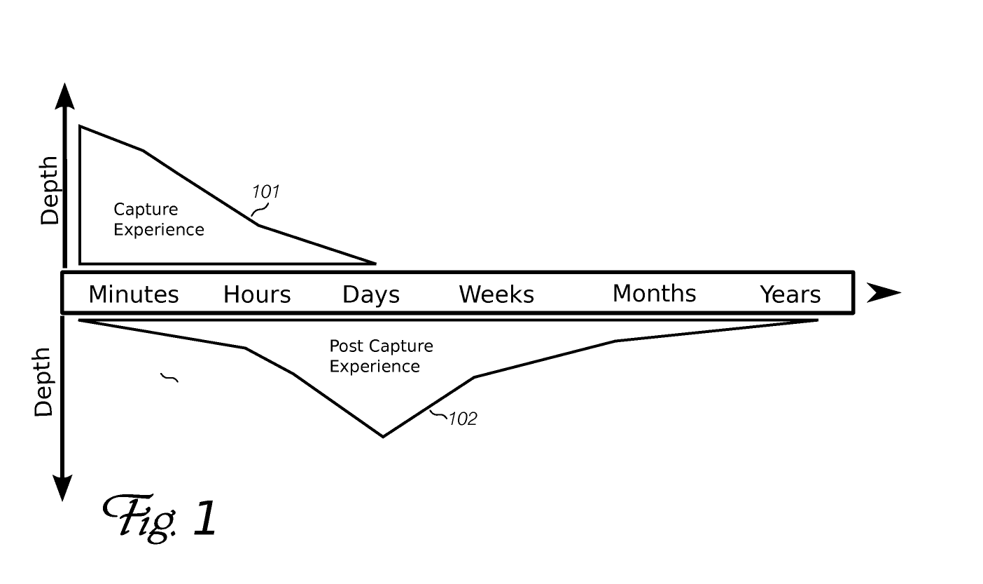

FIG. 2 shows a high-level timeline of the data collection, uplift, and presentation-production operations of an embodiment of the invention.

FIG. 3 shows an assortment of physical sensors and their interconnections that may produce raw data for collection into a multimedia data set.

FIG. 4 shows a diagram of the Event Capture Process

FIG. 5 shows a diagram of the Metadata uplift process

FIG. 6 shows a diagram of the high level Presentation Creation Process

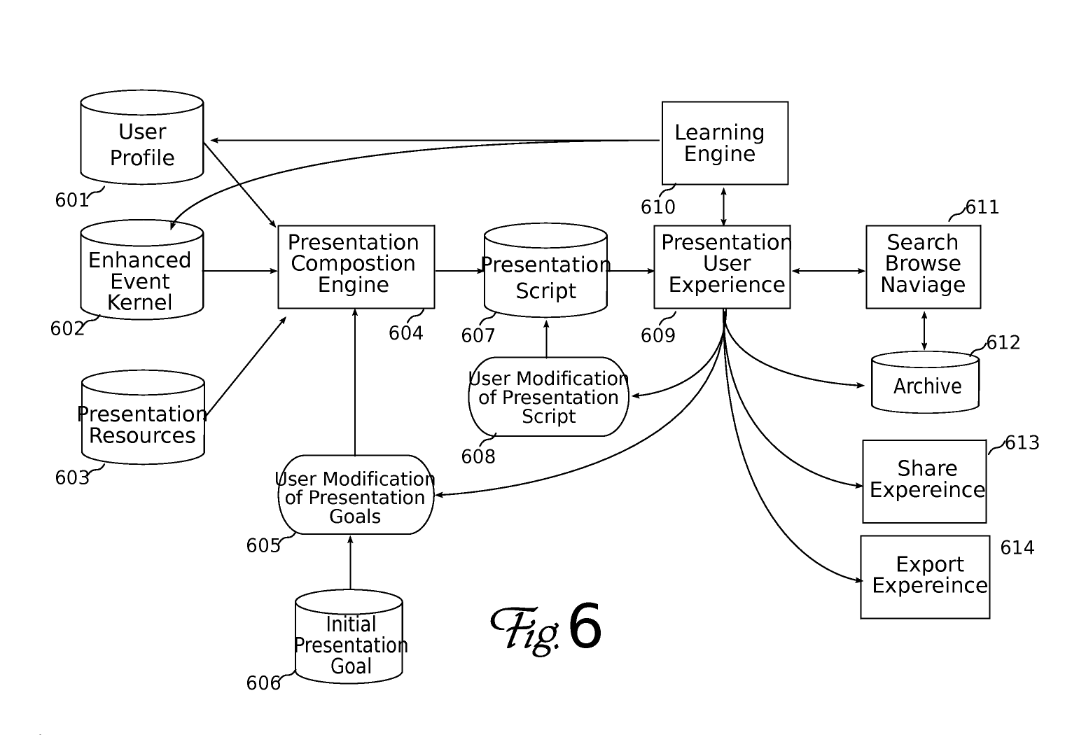

FIG. 7 shows a diagram of the Presentation Engine

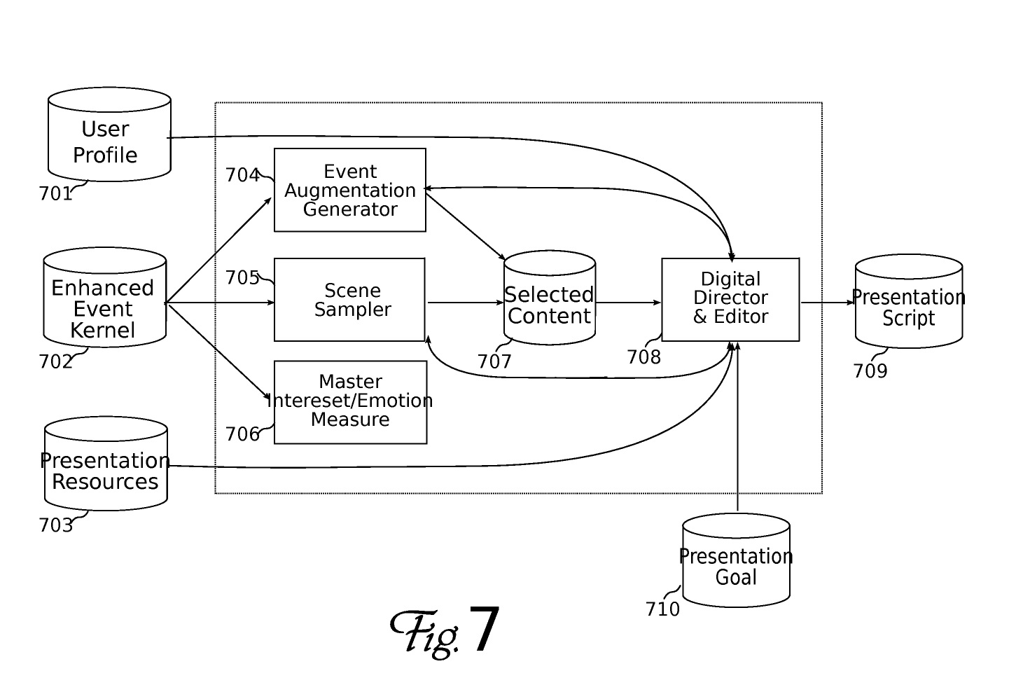

FIG. 8 shows an example plot of individual sensor datastream Interest/Emotion merit functions.

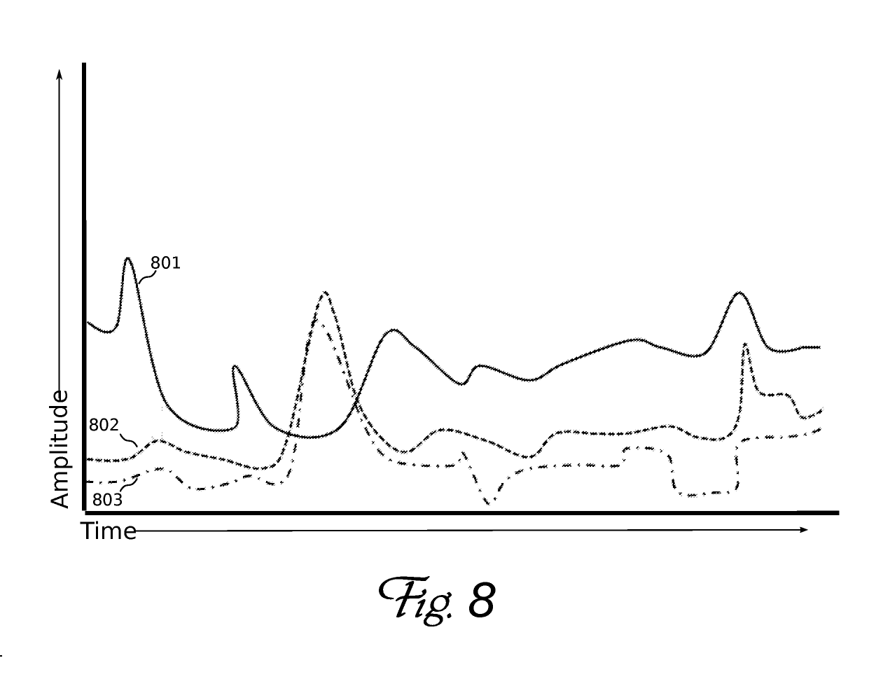

FIG. 9 shows an example plot of the Master Interest/Emotion Measure

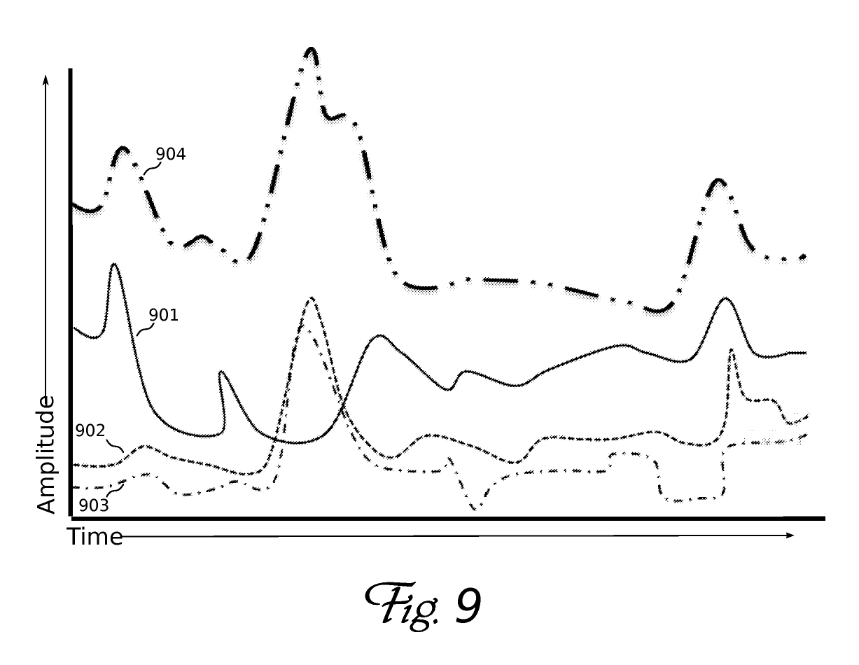

FIG. 10 shows an example plot of how the Master Interest/emotion measure is used with thresholds and offsets to select included content

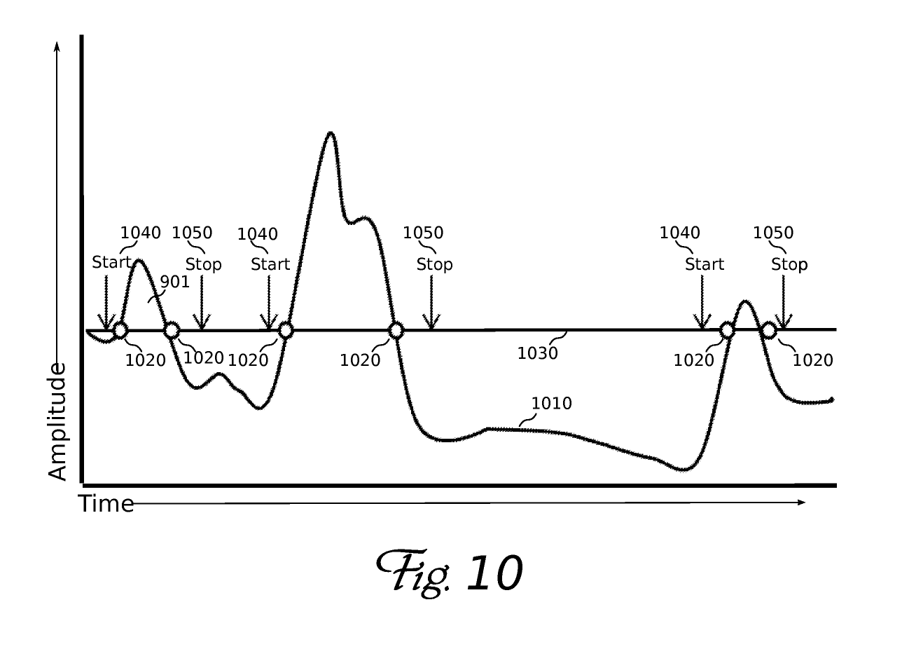

### DETAILED DESCRIPTION

Embodiments of the invention collect data streams from a variety of sources, using inter-stream correlation analysis and heuristics to balance data rates, storage requirements, battery usage and other limiting factors against the expected value or usefulness of the information retained. This information forms a multimedia Event Kernel, which can be augmented later with additional data streams to produce a richer source repository. Then, either automatically or under user direction, a compositing system selects portions of the Event Kernel data and outputs a presentation for an audience. In some applications, audience reaction feedback may be collected and used to extend the Event Kernel further, so that subsequent presentations come closer to achieving particular goals.

Automatic recording conserves resources (or conversely, allows more useful data to be collected with the same resources); while automatic compositing conserves users' time and effort in reviewing and editing the source data to produce a desired presentation.

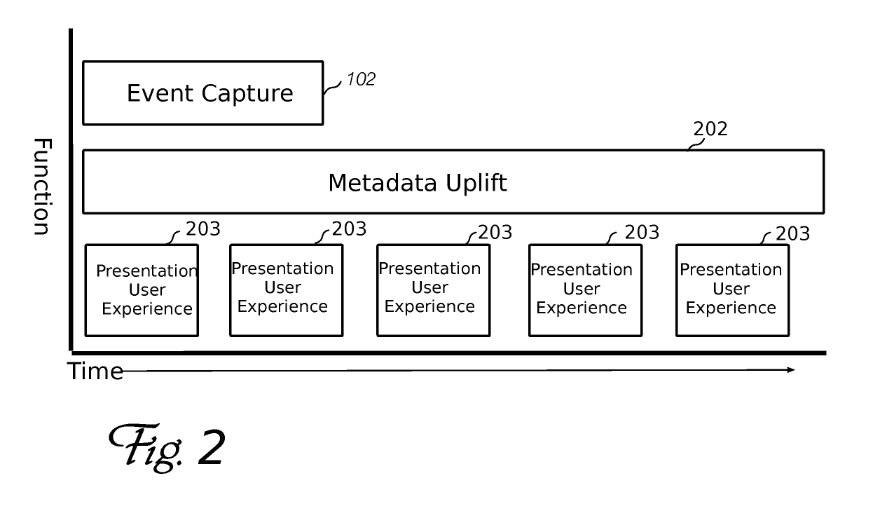

FIG. 2 is a high-level flow chart depicting the three broad categories of operations that occur when an embodiment of the invention is in use. The first is data collection, where sensor devices that measure physical conditions are controlled and queried to obtain raw multimedia data streams. The second is data uplift, where additional data sources and compute resources are queried and the responses used to augment the Event Kernel. Finally, presentation operations select a subset of the data in the Event Kernel that satisfies a particular goal (or set of goals) to produce a program that can be displayed to an audience. As will become clear from the following discussion, there may be substantial overlap between these categories of operations, but generally, collection will happen first, and presentation will happen last. Uplift can occur at almost any time, from during (or immediately after) data collection, to years thereafter. Furthermore, additional data may be collected during program display, and that data made available for subsequent uplift and presentation operations.

User Profile. The User Profile is a body of data collected about the user over time which has the ability to impact the behavior of each part of the system in a way that both simplifies interactions with the user, and allows the system to produce results that are customized to the interests and preferences of the user. Initial user information and preferences are directly entered by the user when the system is first installed. However, the system is constantly looking for opportunities to expand this information over time. This new information is based upon assertions by the user when using the system, observations and trends of user behavior, and information that is gleaned or inferred from user content as the system is used over time. The User Profile contains indentify information, user preferences, use history and key personal context information about the user. The personal context information provide information about key aspects of the user in the “5 W's of Context: Who, What, Where, When, Why”. For example, the “Who” vector would contain information about the user's life and person: Facial recognition parameters, profession, favorite colors, education, etc. In addition, the “Who” vector would contain similar information around other people who are significant in the user's life along with the nature of the relationship. Family members, friends, colleagues, acquaintances could all have entries that become richer with time. The “Where” vector could identify locations that are meaningful to the user. These might include home, work, favorite restaurants, school, ball fields, vacation home, etc. These are places that the user often visits and understanding these patterns and what the significance of each place is helps to put future events into better context. The “When” vector could identify key milestones in a user's life: birthdays, anniversaries, key dates on their calendar, etc. The “What” vector could include key objects or possessions that often appear in a user's life: Cars, bikes, Skis, etc. It could also include activities that are often engaged in by the user: Fishing, skiing, scuba diving, hiking, biking, dancing, concerts, etc. The “Why” vector talks about motivations. For example, vacations, wedding, concerts and sporting events all have an implied “Why”. This information is volunteered by the user when setting up the system, or is inferred through user actions and choices within the context of the system. It can also be inferred by external data. For example if an event location corresponded to a baseball stadium and the date and time correlated to a scheduled game, then motivation of “going to a ball game” can be inferred. Preference information talk about how the user typically uses the system, and as well as various stylistic preferences which refers to how the final product should be prepared to best meet the user's aesthetic preferences. The User Profile is a critical set of information that the system both leverages and builds over time.

Multiple Profiles. It is likely that this system could be used by many people in a single family or by several people in a single organization. Having separate User Profiles for each potential user allows the system to quickly and efficiently adapt its behavior to the User of the moment. While it is possible for a User to swap profiles manually, it would be best if the change in profile was done automatically. This could be accomplished in many ways. Biometric sensors on the camera or Collaboration hub device could identify a user. An example of this is a fingerprint sensor. There are other ways this could also be accomplished. Looking into the camera at the start of the session could used to identify the user. Voice recognition could also be used. Alternatively, you might use a Smartphone or Tablet computer as the Collaboration Hub Device. Typically these devices are customized to the user. The System could select profiles based on the owner of the Hub System. The end goal is to customize the behavior o the system to the User who is capturing the event.

### Collection

Event Driven. Capture is focused on Events. Events are defined as activities that occur within some time period that defines the boundary of an event. For example, one kind of event in the consumer market space might be a party. It starts when you arrive at the party and ends when you leave. In the consumer domain, other examples of an event might be a wedding, a ball game, a hike, a picnic a sporting event etc. Other problem domains may have different kinds of events with different durations. For example a security based system may define an event as a period from midnight to Sam. With a Law Enforcement Camera System, an example of an event might be a traffic stop. During the Event time interval, things can occur that might be of interest to the user. Things may also occur that are not of interest of the user. The capture and collection process is focused on this time interval with the goal of collecting as much information about the event as is reasonable given the length of the event and the available system resources (storage, battery life, etc), so that at a later time, various presentations can be created from this raw captured data. The capture process is focused on direct sensor reading and therefore can only occur during the Event, as this is when the sensors have access to the events as they unfold. Other processing can enhance the amount of contextual information about an event, this processing, referred to here as Metadata Uplift. Uplift can occur an anytime within or after the conclusion of an Event, but Capture is confined to the time boundaries of the event itself.

Event Metadata Kernel. The Event Metadata Kernel, or the Event Kernel for short, is the master file of all information captured related to a specific Event. It is a time indexed file that can hold many different vectors of data that take many forms. Each vector can take its own data formats and encoding, but ultimately is indexed back to the timeline of the event. Some data is high density and continuous—for example, and audio track. Some data is sparse and discrete—for example when certain faces are seen in the video field of view. The simplest version of the Event Kernel is what is produced from the capture and collection process and consists of sensor data captured during the event. The Event Kernel acts as container for this data, and for other information that will be added at later time and by other processes associated with Metadata Uplift, and Presentation Creation, and Presentation Experience related capture.

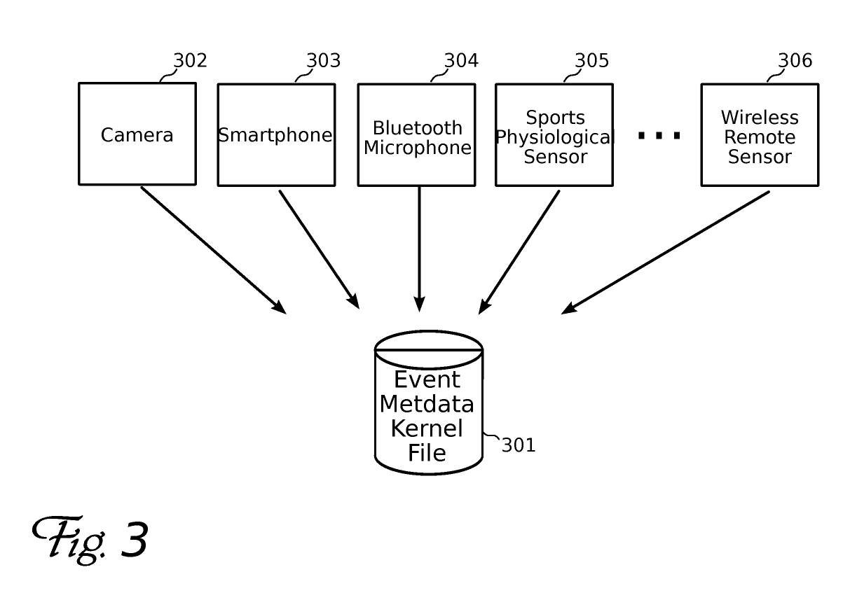

Sensors. The first step in the creation of an Event Metadata Kernel, or Event Kernel for short, is to acquire, optionally sample or filter, and then store information from various sensors which measuring physical phenomena. The principal sensors used in an embodiment are cameras (light sensors) and microphones (sound sensors). However, sensors for a wide variety of other conditions may also contribute their data to the Event Kernel. For example, FIG. 3 represents sensors and connections that might be present in an exemplary embodiment. Sensors can measure time, location, sound, video (visual field), movement, acceleration, rotation, compass direction, altitude, and can include physiological measures of the user such as pulse, blood pressure, skin galvanic response. The number and type of sensors that might become available will expand over time. It is the design of this system to allow new sensors that might become available to be used during the capture process.

Sensor Hosting. Sensors that collect data during an Event can be hosted as part of the camera system, or they could be sensors hosted by other devices that might be available to the user through collaboration. Examples of other devices that could become part of this collaboration: Smartphones, Smart Watches, Exercise Physiological Monitors, other camera systems, remote microphones, etc.

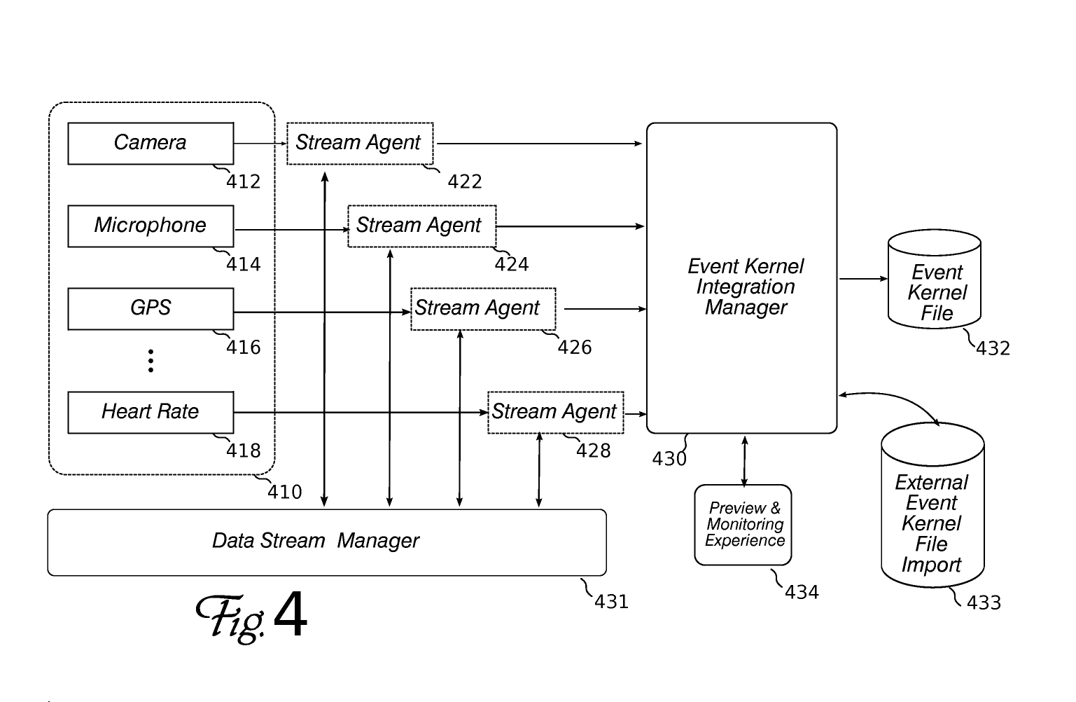

Synchronous Collaboration. Collaboration can be clone synchronously in real-time or near real-time via wireless networking mechanisms such as Bluetooth or Wi-Fi. In this mode, one device acts as the hub of the network, and runs a software agent called the Event Kernel Integration Manager, as shown in FIG. 4, which, in the case of Synchronous Collaboration, manages collecting, collating, correlating, filtering, and encoding the data into a single collection from diverse sources into one data set already mentioned as the Event Kernel.

Secure Wireless Collaboration. In the case where devices are working in wireless collaboration, it is important that security is established in such a system to ensure protect the data stream from unintended or malicious activity. Devices that are collaborating must have authenticated to be part of the user system, and all data transfer should be clone over encrypted communication channels. In this way, the proper devices are involved in the event capture, and the information being transferred is protected from other devices in the vicinity that might be attempting to capture or divert private data.

Asynchronous Collaboration. Collaboration can also be accomplished in an asynchronous fashion. In this case, multiple devices would record sensor data with a time stamp. At some later time, these diverse sources of data are pulled together and assembled into a single collection. This is accomplished by the Event Kernel Integration Manager. It is also possible that another participant in the Event had their own camera system, which recorded the Event Metadata from their perspective. One form of Asynchronous Collaboration is when that person makes the Event Kernel recorded by their system available to the user. This is shown in FIG. 4 as the integration of an External Event Kernel File. In this case, each data stream is identified as to its source and provenance.

Dynamic Sampling Rate. Each sensor must be sampled in order to collect and record information. Many sampling rates and resolutions are possible. A high sampling rate can capture precise changes as they occur, but pay the penalty of creating larger data sets which consume finite storage resources, or drive power usage that can draw down finite battery resources. Depending on what is happening during the event, different sampling rates may be appropriate different times. For example, if an event were a party, where the user stays in one position at for extended periods of time, a GPS sampling rate of once every 60 seconds might be appropriate. However, a user who is moving quickly along a designated route on a bicycle may require a much higher sampling rate to track that movement accurately and to allow for potential motion analysis. An embodiment should not merely record all possible data; it is important to manage available resources (including, for example, battery power and data storage space) and balance them against the expected value or usefulness of the data, so that the Event Kernel can support the creation of a wider range of presentations. Even if no other information is available, an embodiment can implement several heuristics to optimize resource utilization. FIG. 4 show that a Data Stream Agent is created for each sensor, and is responsible for monitoring and managing the information stream from that sensor. The Data Stream Manager monitors each of the Data Stream Agents as well as system resource states. It is responsible for managing the consumption of system resources as well as coordinating the action of the Data Stream Agents in order to effectively collect Event Metadata.

Modification of Sampling. There are several methods that can be used by the Data Stream Agent to modify the sampling rate for given sensor. One binary mechanism is a trigger, where based on a heuristic, the recording of a sensor stream can be turned on or off, thus conserving resources. Another mechanism is to modify the sampling rate and/or sampling resolution. Examples might include changing the resolution or frame rate of video image capture based on the level of activity currently occurring in the visual field. Another example is to modify the encoding of the data when it is stored. For example, higher compression rates could be used when storing video when there is little activity in the visual field, or lower compression rates when there is significant activity in the visual field. The Data Stream Agents monitor the data coming from each sensor. Such monitoring could be as simple as comparing dynamic measures of data being collected to thresholds that would indicate when the sampling rates should be increased or decreased. When these threshold levels are exceeded, the sampling rate can be changed based on heuristics and rules stored with the Data Stream Agent. These thresholds and heuristic and rules are set by the Data Stream Manager as seen in FIG. 4. . In cases where data is not changing rapidly, suggesting nothing of interest is happening, sampling can be reduced and encoding can have greater compression rates. Conversely, metadata collection can be enhanced if the data is very dynamic or measures suggest something of interest is occurring. This throttling insures moments of interest are sampled appropriately while still managing the resources of the system

Sampling and Resource Management. In order to effectively manage sampling rates and resolutions, it is important to understand and track critical resources and their consumption. This job is done by the Data Stream Manager, which uses a rule-based system and a resource budget to manage sampling frequency, resolution, and encoding rates relative to resource constraints. If an event is expected to be two hours in duration, a resource budget can be created and used to modify sampling to insure both adequate coverage of an event while preventing finite resources from being exhausted before the event is over. The Data Stream Managers monitors the Data Stream Agents as well as the System Resources an decides when to change action thresholds used by each of the Data Stream Agents, and can also change the rules and heuristics used by the Data Stream Agents when acting when thresholds are exceeded. Some systems will have the ability to augment resources during an event. For example, battery or memory cards can be replaced thus replenishing resources. In such a system, resource consumption are tracked and the user can be prompted to replace depleted resource pools to allow for continuous even coverage.

Capture Exclusion Zones. There may be times when the recording of information during an event is not appropriate. These times might be defined by social convention (i.e. entering a rest room where others expect privacy) or in some cases by legal constraints. During those times, the user could manually turn off recording. However, with and an automated system, it would be advantageous to have the camera system cease recording during such periods of time. One way of looking at this, is that the sampling rate for sensors goes to zero, and then returns to more normal sampling rates afterwards. There are many ways this could be accomplished. The core notion is that the system responds to some signal to disable recording. This “signal” could take many possible forms. Sensor cues (ex: GPS location) could tell the system to stop capture. Verbal commands from the user via the microphone could be used. Location specific RFIDs or other forms of proximity beacons could be broadcast in a localized area, sensed by the camera, and used to disable recording. One could image a number of such triggers that would cause the system to reduce the sampling rate to zero when desired. The motivations for exclusion zones can change dramatically based on the application, and can driven my many vectors: time, location, based on acoustic cues, visual cues (signs or symbols), transmission cues, etc. Since the nature of the invention is to collects data from the environment during an event, it can be seen that the system can be configured to respond to these “exclusion cues” and reduce the sampling rate of capture to zero across the board.

Sensor Data Provenance. Recorded Sensor data must be accompanied with further information to best understand the nature of the recorded data. This would include the source (which device), sensor type, sampling density and sampling rate (as it changes with time), precision, accuracy, and other information needed to fully interpret the signals recorded. This information becomes part of the Event Kernel and allows downstream applications to understand the nature of recorded data.

User Inputs. User Inputs are actions the user takes when interacting with the camera system. The user can select specific mode of operation or provide information about an upcoming event to be recorded, such as its expected duration. This information can be used to modify how the system behaves during the capture and collection process. These provide parameters to the Data Stream Manager and the Event Kernel Integration Manager that will allow for system optimization. Typical choices that are made by a user can be stored in the User Profile and act a default input where none are offered by the user.

User Collection and Archive of Events. Once collected, the Event Kernel is a Data set that can be stored, archived, indexed, and cross referenced as a entry in a user personal media archive. The Event Kernel can be used for many potential purposes, and can drive the automatic or user driven creation of Presentations that can be viewed, experienced, and shared with others.

### Uplift

Data uplift refers to the processing of physical-sensor data and the addition of non-sensor data to augment the Event Kernel. Some uplifts are simple operations on raw sensor data, and can be performed when or shortly after the data are obtained. Other uplifts require significant time or computational resources, and may be more suitable for offline processing, even long after the original data are recorded. Uplifts may refer to the results of other uplifts.

The Purpose of the Uplift Process. During the Capture and Collection Process, the data recorded from the various sensors during the Event consist of low level data as produced by the sensors. The nature of the data is dependent upon the nature of the sensor. The Video sensor would record a video steam based upon the processing pipeline provided by the capture system hardware and software. The Audio sensor would capture a sound record as digitized and processed by the system. The GPS would record measures of longitude and latitude based upon the sampling rate selected and the real-time accuracy of the GPS satellite signal. Accelerometers and Gyroscopes record motion or rotation in the {x,y,z} vectors they measure within. In all cases, the data collected is the output that is appropriate for the sensor and chosen sampling rate. While this data captures the sensor output, the data alone have very little semantic meaning. The GPS will provide coordinates of where the device is located at a given moment, but tells us nothing about the location we are at, or why we are there. The Video provides an (x,y) grid of pixels that change over time, but does not tell us what those pixels represent. The purpose of the uplift process is to take this low level sensor data and turn it into higher order information with greater semantic value, which can then help to provide greater context for the Event recorded. This uplifted data of can provide clues that allow us to better understand the nature of the Event and what is going on. It can help us to separate those moments of low interest from those moments of higher interest. For example, knowing the geographic coordinates of our location is one thing—knowing that those coordinates correspond to a place we call “home” is a much more useful piece of information. Uplift is aimed at providing new Event Metadata, ultimately derived from low level sensor data, which is fundamentally more meaningful and better able to describe the context of the Event. Sometimes this context is known as the “5 W's”: Who, What, Where, When, Why. If we can provide better information around these key vectors, we will be better able to create presentations which tell the story of the event.

Hierarchical Nature of Uplifted Data. Data uplift is often clone in stages, and because of this, is often hierarchical in nature. One step builds upon the steps that have gone before it. As an example, one can do an analysis on video frames which looks for areas that contain faces. Once this is clone, one can then classify those moments when a person or a group of people can be seen, and record the (x,y) location and size of the detected face. This is useful information, as often images with people in them are of often likely to be of greater interest than those that do not have people included. A subsequent analysis can then be clone just for those frames and frame areas where faces have been located. In this case, biometric facial parameters associated with your family and friends, and stored in your User Profile, can be used for recognition purposes. This creates a higher order vector of information that sits atop the “faces seen” vector and identifies those moments and positions where individuals (whose relationship to you is known), are found within the Event record. Frames with people you know are more interesting that those with those you do not know. Fames with close family may be of greater interest than frames with friends or acquaintances. Further, additional analyses could be clone to assess facial expressions in order to deduce the emotion of the person seen (smiling, laughing, shouting, crying, anger, etc). As another example, Date and Time can be recorded by a clock chip acting as a “time” sensor. An analysis pass might be clone to determine the significance of the given dates or times. By accessing your calendar application the date might be identified as a National Holiday. In another case, your User Profile you might find that a particular date is the birthday of a family member. The time can indicate when an event occurred: morning, noon, afternoon, evening, night. Each portions of the clay is loaded with their own semantic meaning. People seen seated around a table at noon maybe eating “lunch”. A similar gathering at mid morning or mid-afternoon might be a “meeting”. It can now be seen that this higher order information can be very useful and of great value. For example, if you recognized the face of a family member, and it turned out that capture date corresponded to the birthday of that individual, you would now have important clues as to portions of the video that are of greater interest (scenes of the birthday boy on his birthday) and a greater understanding of the context of the event.

Methods of Uplift. There are many possible ways to accomplish Uplift, but in general, these fall into one of three fundamental categories: Analysis, External Reference, and Inheritance. It is also possible to use these methods alone or in combination. These methods can also be used exclusively within a given sensor vector, or could span more than one sensor vector.

Uplift by Analysis. This method consists of doing some numerical analysis of the low level sensor data or lower level Uplift data. One example of this is the process of detecting faces that has already been described. Another might be the analysis of GPS location data to determine motion profiles. For example, when at a social gathering, there is some positional change, however this change is minor and clue to sensor noise or the process of “milling about” at the location of the event. On the other hand, the pattern of locations captured during a hike consists of a series of positions strung out across the path of the hike. The timing of these changing positions can produce a speed measures which allows us to conclude the journey is on foot rather than on a bike or in a car. The Analysis process leverages computer resources, and some stored data useful to the type of analysis being clone, to create new data vectors with a higher semantic load.

Uplift by External Reference. In this case, uplift is accomplished by taking low level sensor data or lower level Uplift data and using external information to create higher order metadata. Taking a date and matching it with someone's birthday or a matching it to a national holiday is one example. Another example would be taking a GPS position and using an external informational service to translate that into either a specific street address, or to a Place Name (Town, City, National Park, etc). In this case, some aspect of the sensor data is used to index higher order metadata through the use of an indexing or lookup service that is fundamentally information based.

Uplift by Inheritance. In this case, Uplift is accomplished by exploiting Uplift operations which have been clone in the past for previous Events. For example, if you had vacationed at the same cottage on a lake over many years, a new vacation event taking place at that same cottage could leverage Uplift operations that have been clone in the past. The Uplift processes could leverage past work by correlating sensor data and inheriting the higher order Uplifted data associated with that sensor data. For example, everything learned about that location in the past could be inherited and used in a new event capture.

Examples of Uplifted Data. There are many possible examples of Uplifted Metadata. Below are some possible examples but it can clearly be seen that there are many more probabilities:
Date/Time Sensor. National Holidays, Personal Events (Birthdays, Anniversaries, Appointments, Scheduled Events).
Video Sensor. Motion Analysis, Scene Classification (Indoors, outdoors, sky/water, foliage, etc), Season, Faces, Facial Expression (emotion), People, Objects, Indentifying and extracting text found with a frame (signs, name tags, etc)
Audio Sensor. Sound vs. lack of sound, Sound Type Classification(voices, laughter, cheering, yelling, music applause, barking, wind, surf, rain, thunder, engine sounds, skiing sounds, etc), If Music is recognized, then use of an internet service to recognize what song is playing, Voice Recognition, Voice Stress Analysis, voice to text conversion, etc. In those cases where there are multiple microphones recording (stereo and three-microphone solutions), it is also possible to triangulate and estimate distance and position of various sound sources.
GPS Sensor. Motion Analysis, Speed, place name, Address, Personally meaningful places (home, school, work, ball field, favorite restaurant, etc).
Accelerometer/Gyroscope/Compass Sensor: Acceleration Analysis, Attitude Analysis, Directional Analysis.
Altitude sensor. Motion Analysis, Accent or Decent Profiles
Temperature Sensor. Ambient Temperature analysis, Rate of change analysis, Seasonal analysis, etc.
Pulse Sensor. Exertion measures, Emotional State estimates, rate of change measures, health measures.
Blood Pressure Sensor. Exertion measures, Emotional State estimates, rate of change measures, health measures
Galvanic Skin Sensor. Exertion measures, Emotional State estimates, rate of change measures, health measures

Uplift Data Provenance and Confidence Measures. Some uplift analysis will have inherent uncertainty. For example, Face Recognition algorithms are probabilistic in nature, and different algorithms will have different rates of success. Because of this, it is a good practice to not only record the uplifted metadata, but also recording the exact method used to compute the data, and where available the confidence level of prediction. This has several advantages. When a new version of method comes along, it is possible to know what data was created with an older version. This allows old data to be replaced with new data computed with the latest methodology. Secondly, a confidence interval allows rule based or other reasoning engines to take confidence into account. For example, a face recognition result with a confidence factor of 60% might be treated differently than one with a confidence factor of 95%.

Multiple Vector Uplift. In general, much uplift will be clone in the context of a single sensor data stream. However, there is often great power in doing uplift that spans several streams. Often uplift within a vector leads to a conclusion. In our example in the preceding paragraph, Face detection and recognition may conclude that a person in the frame is a close friend. However, what can be clone if the confidence in that conclusion is relatively low? One way to address this is to look for supporting information from other vectors. For example, if Face Detection recognized “Joe” with a confidence of 60%, and Voice Recognition recognized “Joe's voice” in the same time period with a confidence of 85%, and Text Recognition from the video sensor stream recognized the word “Joe” on a name tag worn by the person who face was classified as “Joe”, you can make your conclusion with greater confidence. By the same token, mismatches in vector conclusions can also be of value. For example, GPS position Data resolves that you are at a Auditorium. Time/Date sensor data allows you to determine that a rock concert is scheduled at that Hall at the time of the Event Capture. However, the Audio Vector does not pick up significant sound, and no music is recognized. This seems to be a contradiction in vector channels. However, the Accelerometer/Gyroscope sensor indicates that you have walked 50 yards to the edge of the Auditorium, the conflict is resolved as it could be reasoned that you left the hall temporarily to get refreshments. Multi-Vector analysis is a very powerful method to establish context with high confidence, and to better understand the story of the Event captured.

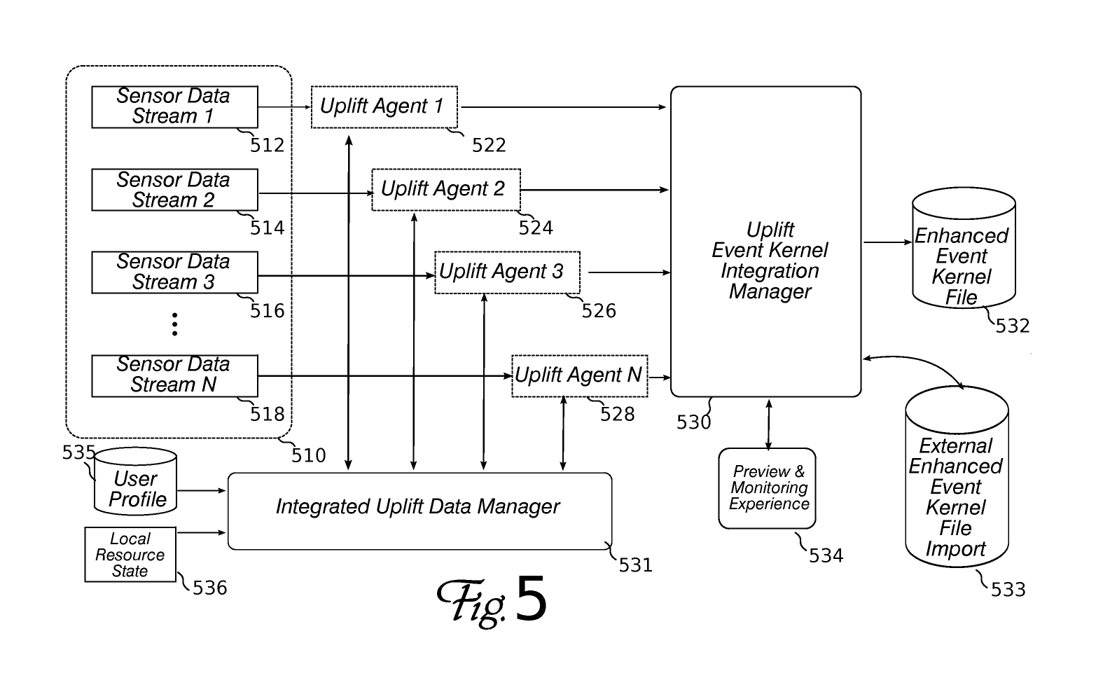

Managing Uplift. The system for managing the computation of Uplift can be seen in FIG. 5. The Integrated Uplift Data Manager controls the entire process. Its spans and controls individual Uplift Agents that are associated with each Sensor Data Stream. Based upon the Uplift operations that has already been done, and the resources available to the system, this manager determines which Uplift operations should occur and in what order. These tasks are assigned to the appropriate Uplift Agents for execution. Uplift Tasks that leverage multiple sensor streams are either done by the Integrated Uplift Data Manager, or are broken into pieces for Uplift Agent execution followed by final processing conducted by the Integrated Uplift Data Manger itself. Tasking is based what Uplift methods are defined and available, resources available, and a rule-based tasking system that drives the decision process. Uplift Methods could be defined as software plug-in modules that can be used either by the Individual Uplift Agents or by the Integrated Uplift Data Manager. These plug-ins may change based on the nature of the computer device, Mode of the Uplift, or availability of various capabilities and versions which evolve over time. The Integrated Uplift Data Manager supports Uplift by Analysis, External Reference, or Inheritance. In order to support this, the Integrated Uplift Data manager has full access to internet services and User Profile Data. The Uplift Event Kernel Integration Manager is responsible for folding newly computed Uplift data into the Existing Event Kernel, managing the correlation, collation and encoding of new vectors, and the integration of these new data vectors with the existing data vectors (both sensor and previously computed Uplift vectors) into a container known as the Enhanced Event Kernel File. The Uplift Event Kernel Manager also has access to the internet and external services, and has the ability to take those Enhanced Event Kernels created by other users and integrate those data streams into a super set when both users have given permission for this to occur.

Relative vs. Absolute Data Encoding. It should be noted that Uplift is often relative to the User Profile information used. When two different Enhanced Event Kernels from different users are combined to create a superset for an event, the encoding of the Uplift data must be clone in a way that has absolute meaning and not relative meaning. As an example of this, someone classified as “Father” is only “Father” to a specific set of people. Encoded in this way, the information is relative in nature, and not as useful to others. A relative version can be created if necessary. For Example, “Father of John Doe” can be converted to “Father” if you are John Doe. Instead, the information should be encoded in an absolute way: “Father of John Doe”. In this case, the information can be integrated into anyone's Event Kernel maintain a useful meaning.

Local Computation vs. Collaborative Computation vs. Remote Computation. The Uplift process can use resources in an efficient way. Uplift Processes can take place on the camera device itself or on other devices in a wireless collaboration. In this case, the Uplift being clone is appropriate for the resources available for each device, and focuses on the sensor data streams collected by those devices. The Uplifted data vectors are returned with the Sensor data streams to the device that is acting as a hub of the collaborative network. Uplift can also be clone by the hub device itself, operating on the collated and integrated Event Kernel Data. Uplift can also occur at later times leveraging other resources that might become available, such as a home computer or a cloud-based server. In one example, the Event Kernel File is automatically transferred to a designated home computer by the hub device when the User returns home, leveraging the local Wi-Fi resources. Once moved to the home computer, the Integrated Uplift Data manger could run on the home computer in the background and take advantage of more powerful compute capability and unused CPU cycles to conduct Uplift operations. For example, Uplift operations could be run overnight when the computer is not in general use. In another example, the Event kernel file is uploaded to a cloud server by the collaboration hub device. A cloud service would then manage the uplift operations and the Enhanced Event Kernel files would be made available to the user.

Modes of Uplift: There are four basic modes of Uplift: IN-EVENT, POST-EVENT, PRESENTATION, and UPDATE. These modes are based primarily upon time relative to the event, and to the availability of additional resources.

IN-EVENT Uplift. IN-EVENT Uplift occurs in near real-time and is computed within the time boundaries of the event, often in near-real-time. In general, IN-EVENT Uplifts are typically computationally simple, and are clone such that the Uplifted data vectors are available almost immediately. This offers several advantages. Should the user stop recording the event and wish to review something that just occurred, the system will have some sensor and uplift metadata available to support this use. Another advantage of near-real-time Uplift computation is that some forms of Uplifted data could be used by the Capture and Collection process optionally for the purposes of determining sampling rates.

Sensor Stream Interest Merit Functions. One example of an IN-EVENT Uplift data vector is the Sensor Data Stream Interest Merit Function. This is a simple to compute vector that looks at a sensor data steam and computes a merit function that indicates when a given moment appears to be of interest, and also determines the relative strength of that interest. The merit function used is entirely dependent upon the nature of the sensor being monitored. For example, the Audio sensor may have a merit function that is based upon the sound level. No sound or low sound might be seen as uninteresting, while more sound and modulated sound might be flagged as more interesting. These vectors could be replaced or augmented by more sophisticated merit function computations that could be computed POST-EVENT, when there is more resources and time available to support this.

POST-EVENT Uplift. On this case, the Uplift process occurs after the event has concluded. This could be minutes, hours, clays, weeks, months, or even years after the event. Some Uplift operations which are computationally intensive might be deferred until other less expensive methods have already been clone, thus optimizing the use of resources. In some cases, higher order Uplift cannot take place until lower level Uplift operations have been clone. POST-EVENT Uplift should be thought of as an ongoing process than continually acts to enrich the information available about an event over time. The availability of new data (inheritance, or the computation of lower level uplift), new or improved methods, or new compute resources over time can act to drive continuing Uplift

PRESENTATION Uplift. At some point in the future, the User will request that the system create a presentation of the Event, driven by established presentation goals. Once this is clone, the user can interact with or react to the Presentation, as it tells the story of the event. Certain actions by the user will provide greater context for the event and can be captured by the system as new Uplift data that has been asserted by the user. An example of this is the user adding captions to some scenes. In other cases, new sensor data could be collected during the viewing process. For example, physiological measures could be captured during presentation. In this case, Uplift could be clone on those sensor measures to estimate the emotional response of the user to the presentation. This data can be added to the Enhanced Event Kernel for future use.

UPDATE Uplift. After the passage of time, new Uplift methods will become available or existing ones will be improved. When system software is updated, an Uplift process can be run to create a new data vector that had not existed before. In the case where an existing method is improved, existing Uplift data vectors might be recomputed to improve the value of the existing Enhanced Event Kernel

Enhanced Event Kernel Collections and Archive. Once uplifted, the new Enhanced Event Kernel is a Data Set that can be stored, archived, indexed, and cross referenced as an entry in a user's personal media archive. In the case where there was already an Enhanced Event Kernel for a given event in the archive, it will be updated with the new information. The Enhanced Event Kernel can be used for many potential purposes, and can drive the automatic or user driven creation of Presentations that can be viewed, relived, and shared with others.

### Presentation (Slides 7 to 11)

The final phase in the operation of an embodiment is the automatic creation of a program for display to an audience, based on information contained in the Enhanced Event Kernel File, User Profile information, Presentation Resources available to presentation creation system and the User input of the goals of the Presentation. At a very basic level, this process simply chooses which information from the Enhanced Event Kernel File to include in the program, and which to exclude. This choice of what to include is mainly determined by the Goals of the presentation as enabled by the presentation resources available and further guided by the history of the user requesting the presentation (User profile). In addition to selecting the data to be included in the presentation the system can perform rendering translations, to present the selected data in an alternate form that better meets the goals set by the presentation goals. Finally, new content can be added via Augmentation, where new visual or auditory content can be created from digital metadata contained in the Event Kernel.

Form of Presentation result: The result of the presentation phase may be a list of instructions and configuration parameters in the form of a script that will control a compositing system. For example, the list may be similar to a Non-Linear Editing (“NLE”) script. This may be significantly smaller than the resulting program but will contain all of the pointers to the selected content for the intended presentation. This script can be used to produce the display program. In another embodiment, the program may recorded for later playback; the recording could omit all of the non-selected material from the Event Kernel to protect the original source material while reducing the ability of a viewer to remix or produce a variant of the program.

Value of the Presentation Script—The scripted result will enable a small size resulting data file, ability to have many versions, ability to allow the user to change the presentation easily, the ability to avoid intensive compute resources involved in transcoding and rendering of video presentation within the system.

Presentation Goals: the presentation goals are the key determining factor for driving the selection of content to be included in the presentation. Goals include production type aims such as the resulting length of the presentation, visual style desired (i.e. black and white video or color), average scene length, scene transition type (fade, hard cut, etc.), audio accompaniment (background music) and other style type decisions. Another element of the goal is driven by the emotional direction that this story this is to represent. This emotional objective is characterized by selecting elements of the event kernel file that contain predominant emotional content such as humor, joy, longing, sadness or excitement. Another element of the goal is the informational content to be included in the presentation such as event time period, location, particular people or type of activity to be included or highlighted as part of the presentation. In addition, the goal will have as a modifier, the type of audience this presentation will be tailored to such as average age, predominant gender of audience, culture of presentation environment or personal relationship to user setting the goal (immediate family, work relationships, general audience with no relationship). If this presentation was targeted towards a specific individual, then a version which chooses content that contains this person might be emphasized.

Presentation resources: these are the tools and external information sources that are available to the story composition engine that will enable the goals of the story to met. The style elements of the goals will be mostly enabled by these resources that could include preset story lines (general flow of a retelling of a wedding event for example), special video (and audio) effects to be applied to selected content (false/modified color to video, laugh tracks to audio) and Informational templates (title and story credits for example). Informational as well as style goals can be addressed by the use of third party content such as background music, inserts from news sources.

User Profiles: Information about the user and their past usage of this story composition engine can be used to modify the goals for the particular story under construction. For instance, if a story under consideration has a humorous goal and it contains new data on college friends, then old yearbook pictures might be included in the story as this theme was used before when college friends were included in previous stories. If past events experienced by this user (or user's family) were captured at this location previous to this new data set , this past information might be included in the present story composition. One could also collect key info on useful context Ws: Who—identity, relationship, facial recognition parameters, etc. Where: key places of interest: Home. Work, School, Little League field., When—birthdays, anniversaries, and so on. The user profile should contain useful background information that can focus presentations in the areas of interest such as the user's birthday and birth place, immediate family members and close friends and important dates for these relationships, Schools attended, Wedding information etc.

Master Interest/Emotional Function: An important element of the presentation engine is the mechanism used to evaluate the “interest” level of the information being considered for inclusion in the presentation under construction. Starting with the Goal of the presentation as guide, the content of the information being considered (in this case the pre existing data stream interest/emotion merit functions) for inclusion in the story is evaluated as to its alignment to the informational goal (interest measure) and emotional goal (emotional measure). For the video, audio and other (physical measurements such as blood pressure) data steams each should have a computed interest/emotional merit function as part of their content. These then can be combined to calculate an overall interest and emotional function that can be measured to correspond to the desired goal of the presentation. If a Goal of a high action/excitement story is input, the portions of the event data that have a combined emotional and interest level that meet the “threshold” for Action/excitement will be candidates for inclusion in the story. It should be observed that this Master interest/emotional function is like a rotating vector that always has a orientation (type of emotion/interest) and a magnitude. The Goal will select the “angle” or orientation of interest (humor vs. excitement for example) and the threshold will indicate the degree or intensity of the emotion of the selected data. The angle may in fact change which vectors are used and what weighting is used to compute the Master interest measure.

Digital Director/Editor: This component of the presentation engine is the compositional decision maker for the presentation. Using the user's story input Goals and having knowledge of the presentation resources and user profiles available, this element composes the presentation using selected elements of the event data into a story script. Like a real life director of a movie, the process is adaptive to the content available as well as trying to adhere to the goals of the presentation. If a party event is to be composed into a presentation and there is an over abundance of humorous content available then the director will select elements to be included that most enhance the story (for example humorous content with the best video or audio quality). Corresponding to the style goals the director could request event content to be augmented or replaced by new representations of the event data (one still image to replace a video clip while audio of scene is played as originally captured). The output of this element is a script that will be used by the story presentation engine to render the script and selected event content as well as third party or augmented content into a story according to the production goals set by the user.

Selection of Included/Excluded Content: This is an important advantage of this system, the automatic selection of the most relevant content of the captured event data in accordance to the presentation goals selected by the user. This meets the goal of minimizing the amount of time the user needs to spend with the system while still producing a useful, informative and entertaining summary of the captured event. This process is also an iterative one where initially selected content may be deselected or modified (duration) as a result of the ongoing story composition process under the direction of the digital director. Elements used to determine the selection are the presentation Goals as well as metrics associated with the event data (informational and emotional measures). These metrics are represented by the sensor metric functions as well as higher order combination of these functions called the master merit function. These functions are the time dependent measures of the relevance or interest the data captured to the particular goals of the presentation. The emotional merit function will provide the time periods of the event when a particular emotion was present ( humor or excitement for example). By comparing these (constantly changing) measures to a goal determined threshold the relevant parts of the data are selected for possible inclusion in the presentation. The portions of the captured data to be included (above the threshold) are modified to include pre and post time periods so as to fully include the context of the event to better serve the composition process. Finally, as part of the recombination process, feedback from the initial viewing of the finished presentation could result in a re-composition of the presentation what would additional selection or exclusion of content.

Augmentation: the augmentation or enhancing of metadata from other information sources is accomplished through the event augmentation generator. This element recasts metadata into other forms more suitable for use in the intended presentation. If, for example location information is to be related as part of the presentation the originally recorded GPS coordinates would be displayed as a map insert or even a photograph of the location designated by the coordinates. This is an example of presenting information in a manner that better fits the goal (style goal) of the presentation. In addition to recasting information, the augmentation element can add additional information in support of the originally captured event data. In the case of location information, historical data about that location can be retrieved from third party sources to be included in the presentation if the goals (informational goals) call for this type of addition. This augmentation activity is clone under the direction of the digital director element as part of the presentation engine. New content that is created by the augmentation process greatly enhances the telling of the story by providing pertinent context. For example, in the case of a Skydiving Event, A map can show where the dive center was, the path of the plane, where the jump was made and where the jumpers landed. As the skydivers are falling through the air, augmented graphic overlays can present the speed of the fall, the skydivers heart rate, and their current altitude. Thus augmented data can greatly enhance the story telling presentation.

Presentation Creation: The scripted presentation is then rendered into a final story presentation that is directly observable by the intended audience. This rendering process involves the selection of the specified event data (video, audio, third party supporting information) and combining them in a sequential timeline with the specified transitions between the selected event data snippets.

Presentation Experience and Exporting and sharing of presentations: The delivery of the presentation to the audience is the point at which feedback as to whether the goals of the presentation were met. This feedback can be explicit, or implicit. The viewer might comment on the presentation back to the user, or the user himself might change or annotate the story. The audience reaction can be gathered in real-time through automatic evaluation of their response to the presentation (physiological response, auditory response) or direct observation by the presenter. This reaction is the information that enables the feedback to determine modification of the presentation to better meet the original goals or to define new goals. It is important to note that the same presentation delivered at different time periods will supply time-advantaged feedback. A presentation delivered soon after the actual captured event will most probably yield a different audience reaction than one delivered a long time after the event. A presentation delivered a long time after the original event would most likely surface additional sources of information (audience feedback) that could enhance the presentation (like another Kibra device that captured event data at this event). This will enable the presentation to evolve over time as new data sources are identified and those existing data sources (third party) are enhanced clue to new information gathered over time. This original presentation can be stored (archived) as a script with original source event data or without the original source event data (which will preserve privacy of original event data). It also can be shared in rendered form that will allow the sharing of the presentation using common social networking platforms.

### Recombination

The retelling of the story (recomposing the presentation after the initial presentation) provides an opportunity to combine audience feedback from the initial story and to benefit from enhanced or improved data sources that have been identified over time. This recombination process enables the modification of the original story and it also provides data about the user that requested the original story composition. Feedback from the original presentation can be used to modify the user profile and alert the system to new sources of information for subsequent versions of this presentation. A big part of the value of this recombination is the repurposing of the event data into a customized presentation with little additional effort on the part of the user. Rapid generation of focused versions of the event presentation based on initial audience feedback (which could just be the initial user himself) and knowledge of new sources of information about this event is a key advantage of this system.

An embodiment of the invention may be a machine-readable medium, including without limitation a non-transitory machine-readable medium, having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), eraseable, programmable read-only memories (“EPROMs”), electrically-eraseable read-only memories (“EEPROMs”), magnetic or optical cards, Flash memory, or any other type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that collection and augmentation of multimedia data streams, and production of various presentations from such data streams, can also be accomplished by software and hardware that distribute the functions of embodiments of this invention differently than herein described. Such variations and implementations are understood to be captured according to the following claims.

We claim:

1. A method for building a Event Kernel, comprising:
acquiring a plurality of contemporaneous data streams describing physical conditions measured during an event, an acquisition rate of said acquiring governed by a heuristic taking as inputs at least one data point from at least one of the plurality of contemporaneous data streams and at least one measure of a limiting resource; and
storing the acquired data.

2. The method of claim 1 wherein the plurality of contemporaneous data streams are chosen from the set consisting of {photo, video, audio, GPS, accelerometer, WiFi beacons, temperature, pressure, compass, heart rate, breathing, Date/Time, skin galvanic response, infrared detectors, humidity, control button state, atmospheric pressure vs. blood pressure}.

3. The method of claim 1 wherein at least one data stream of the plurality of contemporaneous data streams is acquired by receiving a wireless transmission from a device that measures a physical condition.

4. The method of claim 3 wherein the wireless transmission is an encrypted wireless transmission.

5. The method of claim 3 wherein the wireless transmission includes a security authentication data exchange.

6. The method of claim 1 wherein a first acquisition rate of a first of the plurality of data streams is different from a second acquisition rate of a second of the plurality of data streams.

7. The method of claim 1, further comprising:
compressing one of the data streams before storing the acquired data.

8. The method of claim 7 wherein a first compression ratio of a first of the plurality of data streams is different from a second compression ratio of a second of the plurality of data streams.

9. The method of claim 7 wherein a compression ratio of the compressed data stream is different at a first time and at a second, later time.

10. The method of claim 1 wherein the heuristic increases the acquisition rate when at least one of the following conditions is detected: {sound is loud, faces recognized in video, accelerometer peaks, user input received}.

11. The method of claim 1 wherein the heuristic decreases the acquisition rate when at least one of the following conditions is detected: {sound is quiet, video dark or static, accelerometer idle, battery low, storage full}.

12. The method of claim 1 wherein the heuristic incorporates an indication received from a user of a device performing the method.

13. The method of claim 1 wherein the heuristic reduces the acquisition rate to zero when a privacy signal is detected.

14. The method of claim 13 wherein the privacy signal can be derived from an outside source.

15. The method of claim 13 wherein the privacy signal can be detected or inferred from the sensor capture Streams

16. The methods of claim 13 wherein the privacy signal can come from an external source in combination with detection or inference from the sensor capture streams

17. The method of claim 1, further comprising:
transmitting a data point from one of the plurality of contemporaneous data streams to a remote server;
receiving a reply from the remote server; and
storing a portion of the reply with the acquired data.

18. The method of claim 17 wherein the transmitting and receiving operations are substantially contemporaneous with an acquisition of the data point.

19. The method of claim 17 wherein the transmitting and receiving operations occur after storing the acquired data.

20. The method of claim 1, further comprising:
deleting a subset of the acquired data.

21. The method of claim 1, further comprising:
receiving an external data stream from a device measuring a physical condition other than one measured in the plurality of contemporaneous data streams; and
adding the external data stream to the plurality of contemporaneous data streams before storing the acquired data.

22. The method of claim 1, further comprising:
receiving an external data stream from a device measuring a physical condition duplicative of one measured in the plurality of contemporaneous data streams; and
adding the external data stream to the plurality of contemporaneous data streams before storing the acquired data.

23. A method for uplifting data in a Event Kernel, comprising:
scanning through substantially all of a data stream of a Event Kernel containing a plurality of data streams representing contemporaneous physical measurements of a plurality of different conditions, said scanning occurring in substantially temporal order;
obtaining a first insight about a first portion of the data stream of the Event Kernel during said scanning operation, said first insight based on contents of a subset of the plurality of data streams occurring before a time of the first portion;
recording the first insight in the Event Kernel;
repeating the scanning operation;
obtaining a second insight about a second portion of the data stream of the Event Kernel during said repeated scanning operation, said second insight based on contents of a subset of the plurality of data streams occurring before a time of the second portion and before the time of the first portion; and
recording the second insight in the Event Kernel.

24. The method of claim 23 wherein the data stream is a video stream and the first insight is an identification of a person shown in the video stream.

25. The method of claim 23 wherein the first insight is a function of two independent but contemporaneous data streams of the Event Kernel.

26. The method of claim 23 wherein the second insight is a function of the data stream and the first insight.

27. A method for creating a presentation from a Event Kernel, comprising:
separating data points from a plurality of data streams of a Event Kernel into included and excluded sets;
storing information to identify the included and excluded sets with the Event Kernel; and
reproducing data points from the included set for display to an audience.

28. The method of claim 27 wherein the information to identify the included and excluded sets comprises an editing script.

29. The method of claim 28 wherein the editing script comprises a plurality of editing-action specifiers.

30. The method of claim 29 where an editing-action specifier is chosen from the set consisting of {select video clip, select audio clip, insert transition, insert subtitle}.

31. The method of claim 27 wherein separating comprises:
examining audio data points from an audio data stream and adding contemporaneous data points from the plurality of data streams to the excluded set when the audio data points indicate substantial silence.

32. The method of claim 27 wherein separating comprises:
examining video data points from a video data stream and adding contemporaneous data points from the plurality of data streams to the excluded set when the video data points indicate little activity.

33. The method of claim 27 wherein separating comprises:
examining audio data points from an audio data stream to identify at least one of laughter or applause and adding contemporaneous data points from the plurality of data streams to the included set when the audio data points indicate one of laughter or applause.

34. The method of claim 27 wherein separating comprises:
examining audio data points from an audio data stream to identify a voice and adding contemporaneous data points from the plurality of data streams to the included set when a voice is identified.

35. The method of claim 27 wherein separating comprises:
examining audio data points from an audio data stream to identify a predetermined word and adding contemporaneous data points from the plurality of data streams to the included set when the predetermined word is identified.

36. The method of claim 27 wherein separating comprises:
examining image data points from a video data stream to detect faces and adding contemporaneous data points from the plurality of data streams to the included set when the faces are detected.

37. The method of claim 36, further comprising:
attempting to recognize a face detected in the video data stream; and
if the recognition attempt is successful, adding an identity of the person whose face was recognized to the Event Kernel.

38. The method of claim 27, further comprising:
collecting a playback data stream during the reproducing operation; and
recording the playback data stream with the plurality of data streams.

39. The method of claim 27, further comprising:
repeating the separating operation to produce a second, different pair of included and excluded sets; and
storing the second pair of included and excluded sets with the Event Kernel.

40. The method of claim 27, further comprising:
recording a playback data stream on a computer-readable medium during the reproducing operation.

41. The method of claim 27 wherein reproducing data points comprises:
creating a graphical figure to represent a scalar measure recorded in the Event Kernel; and
compositing the graphical figure with a video output stream.

42. The method of claim 41 wherein the scalar measure is one of a temperature, a heart rate, a velocity, an acceleration, an altitude, a throttle position or a brake position.

43. The method of claim 27, further comprising:
computing an uplift from data in the Event Kernel and data obtained from a source outside the Event Kernel; and
storing the uplift in the Event Kernel, wherein
the separating operation refers to the uplift for determining whether a data point belongs to the included set or the excluded set.

44. The method of claim 27, further comprising:
retrieving supplemental data from a source outside the Event Kernel, said supplemental data identified by reference to data contained in the Event Kernel, wherein
the reproducing operation includes reproducing a portion of the supplemental data.

45. The method of claim 44 wherein the supplemental data is a geographic map, the data contained in the Event Kernel is GPS data, and wherein
reproducing a portion of the supplemental data is animating a track on the geographic map based on the GPS data in the Event Kernel.

46. The method of claim 27, further comprising:
computing an emotional merit function based on the data streams in the Event Kernel, wherein
the separating operation distinguishes between included and excluded data points by comparing a value of the emotional merit function with a predetermined threshold value.

47. The method of claim 46, further comprising:
receiving a sequence of target emotional merit function values, said values corresponding to phases of a story template, and wherein
the separating operation is to select included data sets that satisfy each phase of the story template.

48. The method of claim 27, further comprising:
receiving commands from a human editor during the separating operation, said commands to alter an automatic decision of which data points to include and which data points to exclude; and
altering the information to identify the included and excluded sets before the storing operation.

49. The method of claim 27, further comprising:
altering an order of data points in the included set so that the included data points are reproduced out of temporal order.
